(19) United States
(12) Patent Application Publication
(10) Pub. No.: US 2015/0347960 A1
(43) Pub. Date: Dec. 3, 2015

(54) CARGO HANDLING SERVICES AND SYSTEMS

(71) Applicant: Cargo Airport Services USA, LLC, Jamaica, NY (US)

(72) Inventors: Tom Choi, Trenton, NJ (US); Li Zhao, North Babylon, NY (US); Vida Lee Shaver, Massapequa, NY (US); Michael Serzo, Queens Village, NY (US); Albert Kim, Oakland Gardens, NY (US); Cecilia Lim, Oakland Gardens, NY (US); San M. Chu, Bayside, NY (US); Dong Hyun Kim, Gyeonggi-do (KR); Sung Sub Moon, Edgewater, NJ (US)

(21) Appl. No.: 14/571,908

(22) Filed: Dec. 16, 2014

Related U.S. Application Data
(63) Continuation of application No. 13/655,085, filed on Oct. 18, 2012, now abandoned.
(60) Provisional application No. 61/548,400, filed on Oct. 18, 2011.

(51) Int. Cl. G06Q 10/08

(52) U.S. Cl. CPC G06Q 10/0833

(57) ABSTRACT

The present invention related to a system and computer-implemented method directed to cargo handling services. A stakeholder captures airline data and customer related cargo data and transmits the data to at least one other stakeholder through either a customer service portal or a mobile warehouse management system. The system is a cargo management system comprising three parts. First, a messaging engine adapted to transmit airline data. Second, a customer service portal receives data from the messaging engine for a stakeholder, such that the stakeholder may manage, track, or reconcile a cargo shipment. Finally, a mobile warehouse management system implemented for recording data and tracking cargo in real-time.

### CROSS-REFERENCE TO RELATED APPLICATIONS

This application is a continuation application of U.S. application Ser. No. 13/655,085, filed Oct. 18, 2012, now pending, which claims priority of U.S. Provisional Patent Application, Ser. No. 61/548,400, entitled “Cargo Handling Services And Systems,” filed on Oct. 18, 2011. Each of these applications is hereby incorporated by reference herein in its entirety.

### FIELD OF THE INVENTION

The present patent application is directed to a system and a computer-implemented method for cargo management, and more particularly, to a system and a computer-implemented method that automates cargo handling information and logistics and provides online real-time access for stakeholders.

### BACKGROUND OF THE INVENTION

The cargo handling industry is a morass of different and varied transportation, temporary storage, and transfer handling mechanisms. Before reaching its destination, a typical piece of freight will travel through several trucks, airplanes, and handling facilities. Generally, each industry owns its own systems, means of communication, and means of documentation. The interaction between these industries is only the beginning of this logistical problem.

A circumstance envisioning one airline with its own ground handling and one trucking company is possible. Yet, a far more likely scenario is multiple different trucking companies, at least one air carrier, and multiple different ground handling companies. For example, the air carrier has ground handling in the origin city, but not in the destination city, and, therefore the airline transfers an airway bill and flight manifest to foreign ground transportation and trucking.

To further complicate things, there is no uniformity within the industries. That is to say, one airline will follow a specific set of shipping procedures and another airline will follow a different set. It is unfortunate; however, that the same is true with respect to the trucking industry, as well as the ground cargo handling industry.

Even more importantly, the methods of tracking and accounting or documentation for cargo through these different industries and companies increases the complexity of the transfers. Some companies use industry standard software, while still others have created homespun spreadsheets or templates and others rely on paper files. The flow of information significantly impacts the ability of a freight owner or receiver, to keep track of cargo. This is especially true when cargo shipments are late, misplaced, lost or damaged.

In some cases, electronic messages are not exchanged by stakeholders as the entities rely on paper documents to support the performance of their respective tasks. In other cases electronic messages are shared. Yet, the flow of data may generate duplication and errors. Finally, in other cases electronic messages are shared, but paper documents are still received and the primary reference used to validate. Therefore, there is a need to provide a system and method for more efficiently managing cargo.

### SUMMARY OF THE INVENTION

The inventors of the present system and computer-implemented method are acutely aware of the manual and protracted process of tracking cargo information. These inventors are aware that stakeholders within the logistical chain are often unable, with any certainty, to extract key information, such as the location, piece count, special handling requirements, weight, and dimensions for themselves, the cargo owner, or other entities in the logistical chain. Further, on delivery and in the event cargo is damaged, there is often no way to determine where in the logistical chain the damage occurred resulting in difficulty for the cargo owner when making an insurance claim.

The present invention overcomes limitations of the prior art by providing a first of its kind system and improved computer implemented method for automating the often cumbersome aspects of cargo handling, while also providing real-time feedback to stakeholders.

The present invention is a cargo management system and improved computer implemented method for overseeing all aspects of cargo handling. The system connects the cargo to its accompanying data and conveys both as an interconnected pair through every transfer from origin through destination. The system tracks cargo and cargo data, including flight data, tracking, payment, and discrepancies as the pieces move through the logistical chain. In this manner, stakeholders have access to real-time updates to track cargo throughout shipment process. Further, this is all accomplished in an automated manner with the option of auto-notification to these stakeholders.

As such, the present invention is a computer-implemented cargo management system. This system has a customer service portal for a stakeholder to manage, track or reconcile a shipment through the internet, and additionally, the system has a mobile warehouse management system. Further, the system has a messaging engine for transmitting airline data via the International Air Transport Association messaging to the customer service portal and the mobile warehouse managing system.

The mobile warehouse managing system comprises at least one SmartDevice with an application that allows for electronically transmitting cargo handling data in real-time to stakeholders within the logistical chain and to the customer portal. A SmartDevice is any device or tablet device with an Apple iOS or Android OS mobile device offering advanced capabilities or other comparable device, including personal computer-like functionality (PC-mobile handset convergence) or a palmtop computer.

Additionally, the computer-implemented cargo management system may include at least one SmartDevice located in a parking area to allow a trucker to check into the warehouse immediately upon arrival. The SmartDevice and application captures details for the trucker. The details are communicated to a SmartDevice which is located in a warehouse and/or an office. Following communication of the trucker details, the trucker can directly proceed to a dock door for acceptance, signoff and receipt of cargo or remain parked waiting for the warehouse to complete a buildup delivery of the cargo. Also, a SmartDevice and application is located in the warehouse. The SmartDevice with application displays a prioritized list to prepare the cargo for acceptance or delivery.

As can be appreciated the SmartDevice can accomplish many task such as identifying special handling, prioritizing breakdown or delivery or creating a build up for selected air flights by adding freight to a skid. A skid is a temporary location for cargo, for example, a pallet. The SmartDevice can be mounted to a warehouse transport vehicle, for instance, a forklift. Many other tasks may be accomplished using a SmartDevice and application, such as determining the time for adding or removing cargo from a skid; notifying the warehouse when at least one trucker is checking in and waiting to drop off or pickup cargo; allows centralized viewing of all booking and acceptance of cargo and shipments and data related to those entries.

Additionally, the present invention includes methods for handling cargo that use a computer program that has a computer usable medium and computer readable program code therein. The computer readable program code is adapted to be such that it executes to implement the method for cargo handling. The present invention thus captures airline data via the International Air Transport Association messaging and identifies to the customer, the cargo data. This data is transmitted to a customer portal and a mobile warehouse management system (for example, a SmartDevice) found in a warehouse. The data is then uploaded or transmitted from the SmartDevice to at least one other SmartDevice and to the customer service portal to access the data in real-time, while the cargo is processed through the logistical chain.

The present methods for handling cargo includes dealing with IATA messages, including, for example: FFM, FWB, FHL, and FSU(RSC) messages. Additionally, data can be identified for a customer and that customer can access the data. Identifying can be done through a Bar-Code Pickup Pass, using Trace and Track, which can be consolidated into a business report that a customer may select filtering parameters, such as AWB, location, payment, consolidation, partial payment, proof of delivery, inbound shipment, freight condition, piece count, weight, customs release, and discrepancy.

This method can also make electronic payments for messaging by the customer, even through email or wireless device messaging, Airline data can also be captured by manually entering AWB information in the event an unmessaged airline is involved.

The present invention correlates the cargo and its data throughout the logistical chain. The system reduces the manual nature associated with the documentation, thereby limiting errors and increasing efficiency. Finally, the information is maintained electronically throughout the process by one provider, thereby eliminating the date processing and format disconnects of the prior art.

### BRIEF DESCRIPTION OF THE DRAWINGS

The invention will become more readily apparent from the Detailed Description of the Invention, which proceeds with reference to the drawings, in which:

FIG. 1 displays the ePic login screen;

FIG. 2 shows the payable items screen displays after user successful login to ePic;

FIG. 3 an illustration of ePic Navigation tabs, buttons, and shortcuts;

FIG. 4 shows a navigation screen with filtering by airport code tab;

FIG. 5 shows a search screen with searching options dropdown menu;

FIG. 6 shows a report screen of epayment tab information consolidated in a single report;

FIG. 7 displays a my profile ePayment user summary screen;

FIG. 8 displays an administration operator access screen;

FIG. 9 displays an administration super admin users setup screen;

FIG. 10 shows a paying ISC screen;

FIG. 11 shows a paying storage screen;

FIG. 12 displays an epayment edit shipment screen;

FIG. 13 shows user cart screen;

FIG. 14 shows a payment for an unmessaged shipment;

FIG. 15 shows an epayment screen utilizing the search and pay for messaged shipments;

FIG. 16 shows a pay for partial shipments screen;

FIG. 17 shows a screen displaying a prioritized list of freight arriving at the warehouse;

FIG. 18 shows a screen displaying list of truckers that have checked in and are waiting to pick-up their freight;

FIG. 19 displays a screen showing an online freight build up and creating of a pallet;

FIG. 20 shows an online tool allowing agents to capture AWB data electronically for airlines that do not provide message data;

FIG. 21 Illustrates a display of all captured office related export acceptance data;

FIG. 22 shows a real-time centralized view of all import processes captured in a warehouse or office;

FIG. 23 illustrates a real-time centralized view of all export processes being captured in the warehouse or in the office; and

FIG. 24 shows the airline portal allowing customers access to their flight data.

### DETAILED DESCRIPTION

The present invention is as described hereinbelow, including detail to exemplary embodiments of the invention. Examples of these exemplary embodiments are illustrated in the accompanying drawings. While the invention is described in conjunction with these embodiments, it will be understood that it is not intended to limit the invention to the described embodiments. Rather, the invention is also intended to cover alternatives, modifications, and equivalents as one of ordinary skill in the art understands the invention.

In the following description, specific details are set forth in order to provide a thorough understanding of the present invention. The present invention may be practiced without some or all of these specific details. In other instances, well-known aspects have not been described in detail in order not to unnecessarily obscure the present invention.

In this specification and the appended claims, the singular forms “a,” “an,” and “the” include plural references unless the context clearly dictates otherwise. Unless defined otherwise, all technical and scientific terms used herein have the same meaning as commonly understood to one of ordinary skill in the art to which this invention belongs.

The invention is directed to cargo handling services and systems, including online Trace and Track features with complete shipment information, auto-notification of import cargo status, quick online payment for import service charge and storage, instant bar-coded cargo pickup authorization pass, carrier certificate in soft copy, among other features. These features are discussed below in connection with the assignee of the present patent application's use of the “ePic” engine, “ePic 1,” “ePic 2,” and “ePic 3.”

The “ePic” engine is a single point of entry for airline related messaging including FFM, FWB, FHL and FSN. These and other acronyms herein are well understood in the industry and defined or explained further in the publication by the International Air Transport Association (“IATA”) “IATA Freight Forwarder—Carrier—Ground Handling Agent Communication Functional Specifications,” (“TATA Functional Specifications”), dated Sep. 29, 2008, which is available at the website: http://www.iata.org/SiteCollectionDocuments/Documents/IATAFFCarrierGHAFunctiona 1 Specificationsv07.pdf. The entire contents of the IATA Functional Specifications publication is incorporated herein by reference.

For completeness some key definitions are provided. All documents indicated may refer to electronic documents. Electronic documents include documents, forms, and messages received by or directly entered into the ePic system. Non-electronic documents, such as an unmessaged documents, for example an AWB not entered into ePic, may be entered and become part of the ePic system.

Cargo data shared among stakeholders includes: an airway bill, a piece count, discrepancy, weight, dimensions, a signed approval of freight tendered, a confirmation of a truck driver from a stored comparison photo, flight number, flight arrivals, flight departures, incoming flights, outgoing flights, a photo documenting freight condition, screening steps taken, buildup data, breakdown data, and special handling requirements and codes.

An air waybill (“AWB”) is a document made out by or on behalf of the shipper, which evidences the contract between the shipper and airline(s) for the carriage of cargo over the routes of the airline(s).

A consignment is one or more pieces of goods accepted by the airline from one shipper at one time and at one address, receipted for in one lot, and moving on one air waybill or one shipment record to one consignee at one destination address. For purposes of this application, consignment is also referred to a cargo and freight.

A flight manifest contains the details of consignments loaded onto a specified flight.

A freight forwarder is the party arranging the carriage of goods including connected services and/or associated formalities on behalf of a shipper or consignee. A ground handling agent is the entity authorized to act for or on behalf of the carrier, for accepting, handling, loading/unloading, transiting, or dealing with cargo, passengers and baggage.

A house waybill (“HWB”) is a document made out by an agent/consolidator specifying the contract between the shipper and the agent/consolidator for the arrangement of carriage of goods.

A house manifest is a document containing the same information as a cargo manifest and additional details on freight amounts, etc.

A receipt for the cargo (also known as “cargo receipt”) is a document, which is provided to the shipper, upon shipper's request, by the carrier creating a shipment record as a substitution for the issuance of an air waybill and which permits identification of the shipment.

A shipment record is any record of the contract of carriage preserved by carrier, evidenced by means other than an AWB. The shipment record is initiated by the FWB information and confirmed or modified by the subsequent FSU(RCS). FSU/RCS would only modify the information regarding total number of pieces (“piece count”), weight, and volume amount of the shipment (“dimensions”).

An FFM message provides the details of consignments loaded onto a specified flight.

An FHL message (type 1) provides a checklist of freight forwarder HWB associated with a master AWB.

An FHL message (type 2) provides details of one HWB consignment for the carrier to provide customs with advance information based on the HWB information provided by the origin freight forwarder. The message containing the HWB data may be sent by the origin freight forwarder and may be updated by the origin ground handler.

An FWB message is used to transmit a complete set of AWB data in accordance with the IATA Cargo Services Conference Resolutions. The message containing the AWB data may be sent by the origin freight forwarder and may be updated by the origin ground handler to include data, such as weight, number of pieces, volumes.

An FSU(RCS) message is used to notify/update interested parties with a change of status of a specified consignment as recorded in the system of a handling party. The RCS specifies that the consignment has been physically received from the shipper and is considered by the carrier as ready for carriage on this date at this location.

Stakeholders may include: the cargo shipper, customs broker, consignee, cargo receiver, trucker and/or trucking company, freight forwarder at origin, air carrier, air carrier's offices at origin, air carrier's offices at destination, ground handling operations/agent at origin, or ground handling operations/agent at destination.

A freight forwarder organizes shipments from origin to destination.

A carrier simply transports goods, for example: a trucker, train, airplane, etc.

A ground handling agent processes inbound and outbound information regarding the physical flow of the consignments.

Messages entering the epic engine are interpreted and made available through the system and computer-implemented method of the present invention.

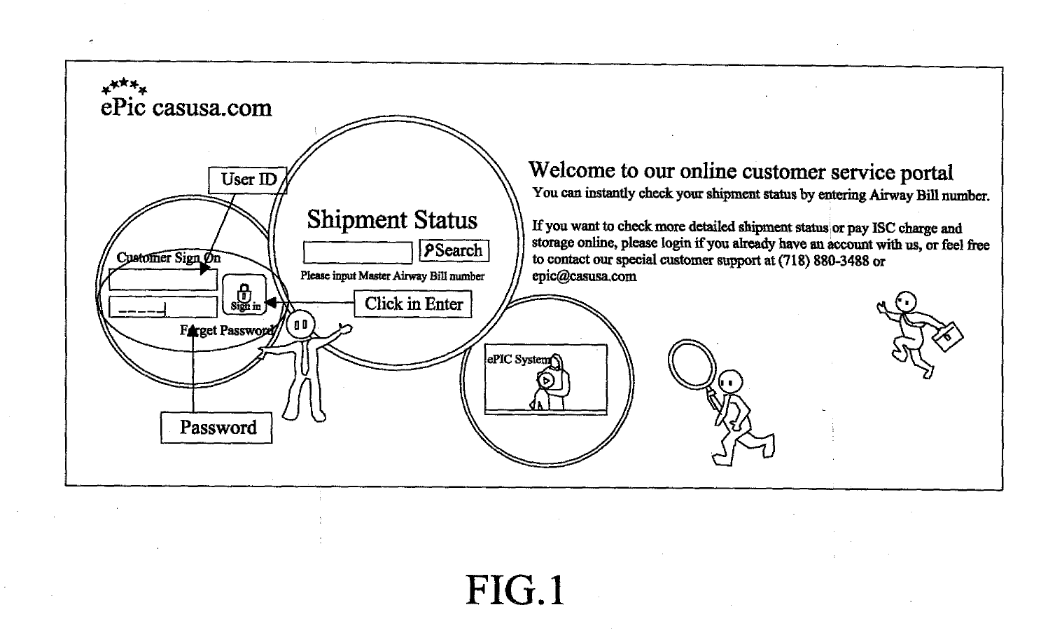

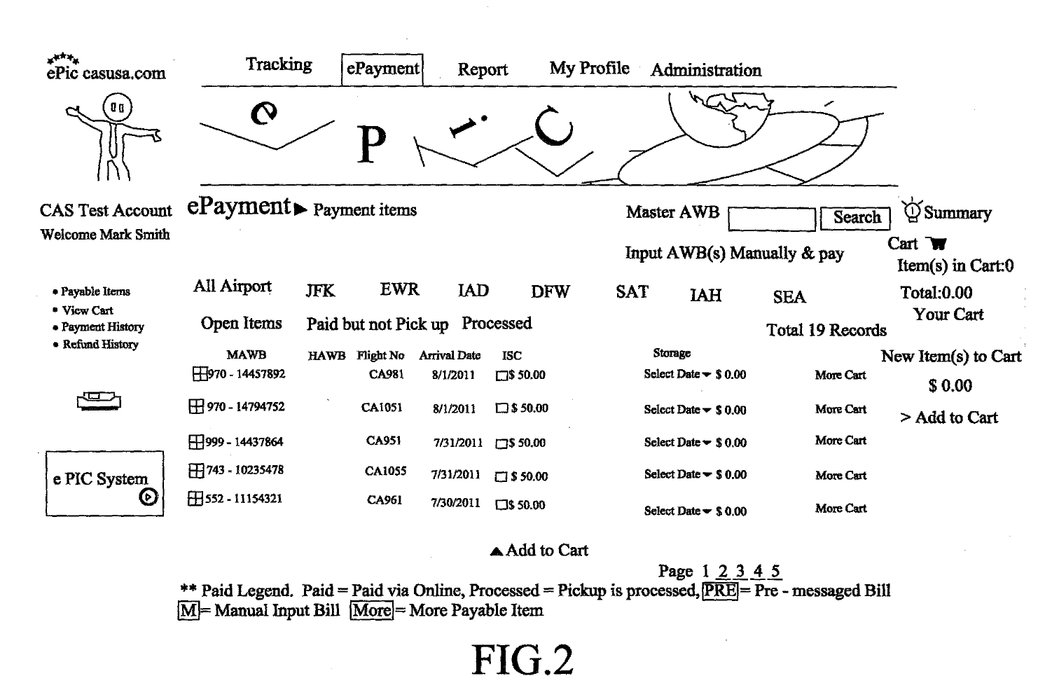

ePic, the customer service portal, is a web based application that is accessed via the internet for online payment and access to data. A user/stakeholder must successfully login to ePic. FIG. 1 shows the user login screen display. FIG. 2 illustrates the initial screen display, ePic payable items, following a successful user login.

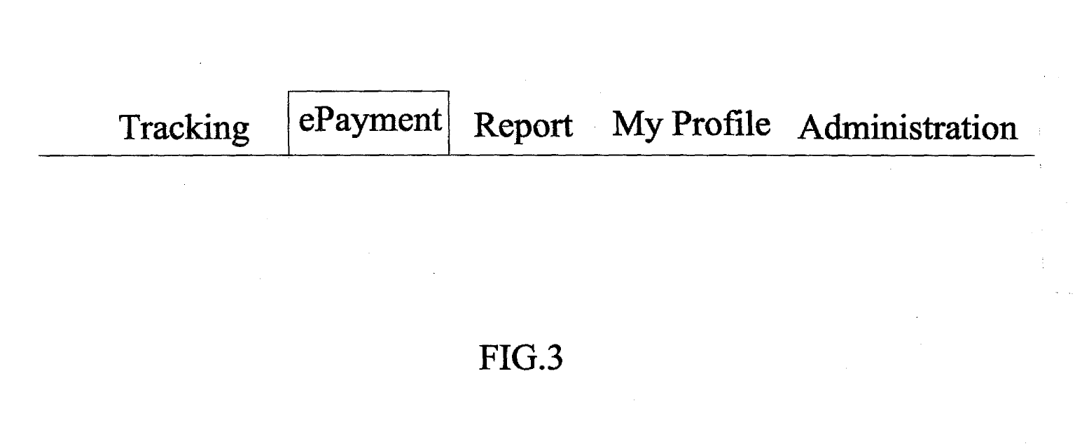

The user is directed to navigation tabs, buttons, and shortcuts along the top of the initial screen display. FIG. 3 is an illustration of ePic Navigation tabs, buttons, and shortcuts. The displayed navigation tabs include Tracking, ePayment, Report, MyProfile, and Administration.

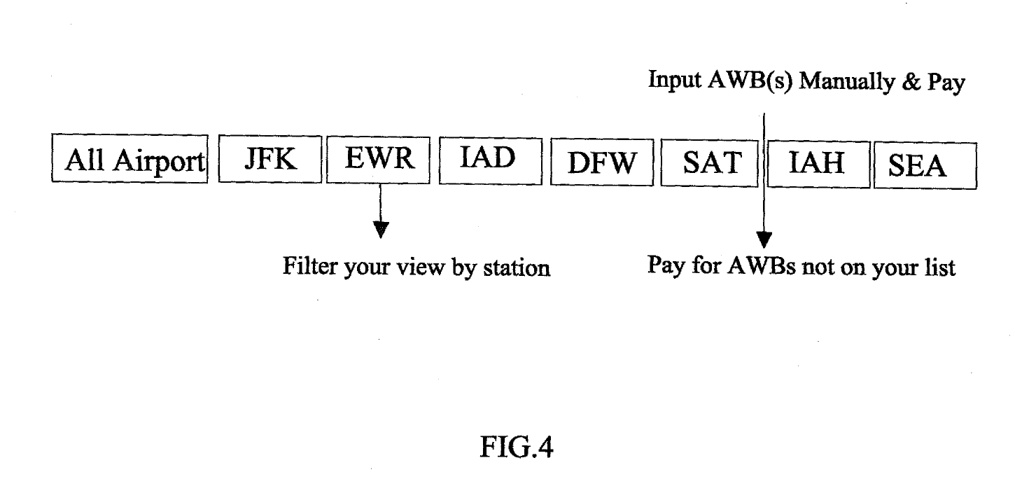

The ePayment navigation tab displays all items in the payment process including: Unpaid, Paid but not picked up, and Delivered. The user's screen is filtered by clicking on the various buttons at the top of the screen. Various parts of the application are accessed by clicking on the tabs. These buttons used for filtering are only accessible when the user is in the ePayment tab. Alternatively, the user may click on the Payable Items shortcut. There is a list of shortcut items on the left the left hand side of the screen. These shortcuts include Payable Items, which lists shipments in various stages of payment; View Cart, which contains the user's shopping cart items for when the user is ready to pay; Prepaid Balance, which is a view of the user's balance and further containing the option to replenish the account; and a Payment History, showing all receipts. FIG. 4 shows a navigation portion of the screen with filtering by an airport code tab.

The Tracking navigation tab displays all shipments paid or open and allows the user to print carrier certificates for all user consigned messaged shipments. Many airlines provide freight messaging (FFM, FWB, FHL and FSN). Freight messaging is received on flight lift off from the point of origin. After receiving messaging, a user may access to a number of features, including: Click and Pay, Trace and Track, Online Carrier Certificates, and Customs Release interpretation. A user is able to pay for shipments prior to a time when messaging arrives through the Input AWB(s) Manually and Pay feature.

While the present invention envisions 100% industry participation, unmessaged airlines likely will be carriers. Unmessaged simply means that freight messaging is not directly entered into ePic. Yet, a user manually entering the AWB information. Once entered, the user may pay for all of his shipments and perform any other task online through ePic.

The Report navigation provides detail and summary reports of paid items. All users have access to the report Paid and Waiting to be Picked up. This is the same information that appears in the ePayment tab. But this information is conveniently combined in one report.

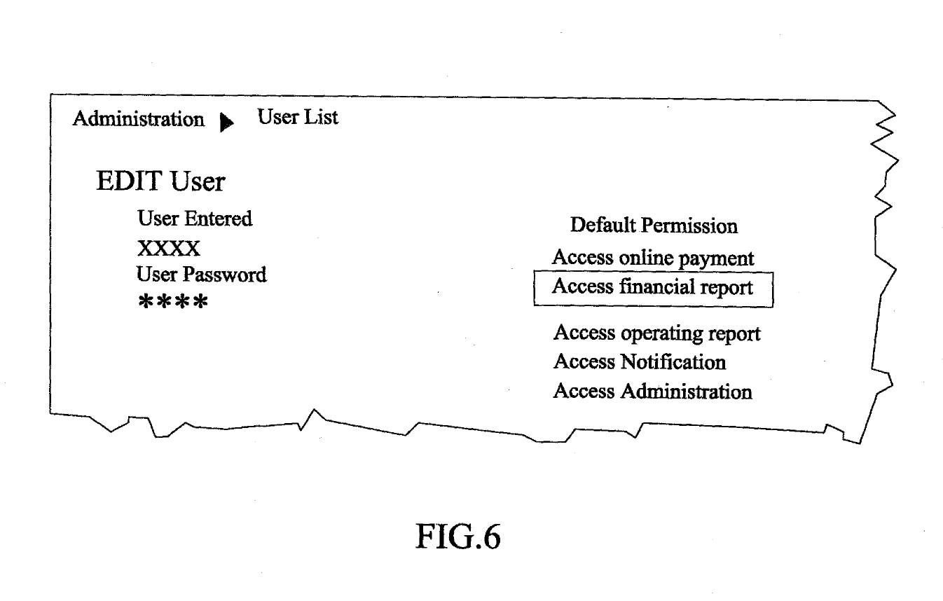

There are several financial reports that are available as well. The user must have advanced access granted from a Super Admin user to access financial reports. The financial reports include both summary and detail reports. Summary reports are available by Airline and by User. Detail reports are available by Airline, by User, by Payment Type, and by Master/House AWB. All reports can be exported to Excel. FIG. 6 shows a report screen of ePayment tab information consolidated in a single report.

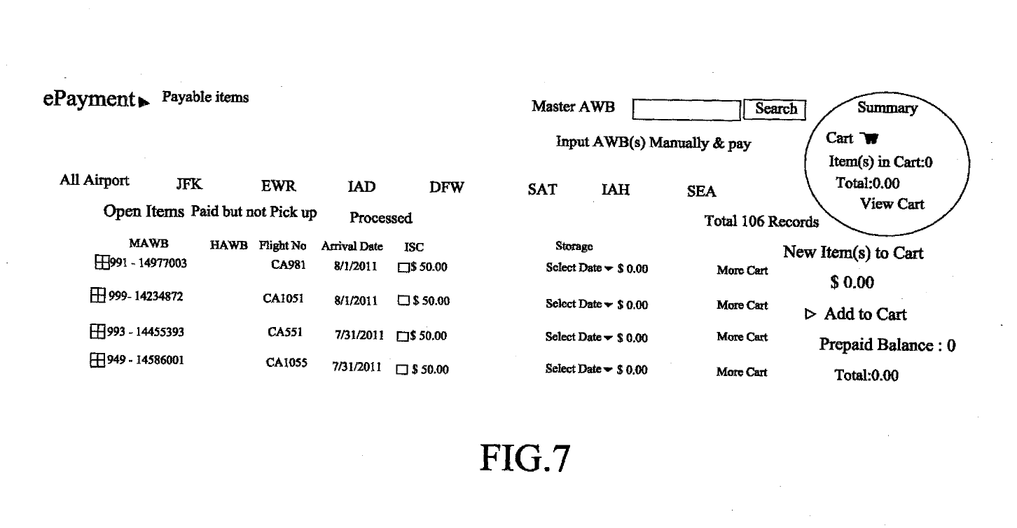

The My Profile navigation tab permits the user to change a password and update the user profile. FIG. 7 displays a My Profile ePayment user summary screen.

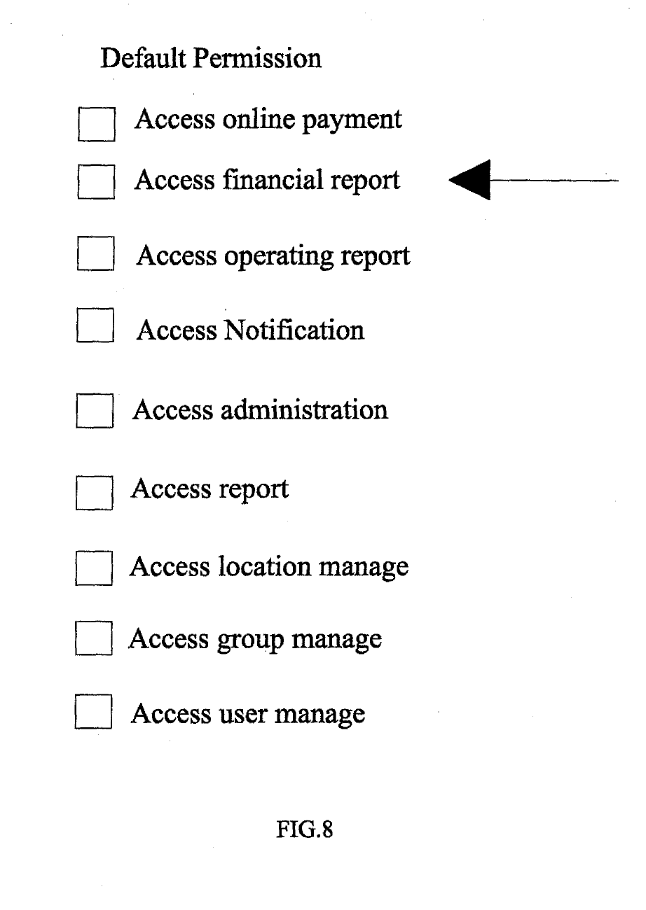

The Administration navigation tab is only visible to Super Admin level users. Only online users with Super Admin or Admin privileges can see this tab. There are three main user types. First, Super Admin user has full access to ePic and is responsible for setting up users and users' rights. The Super Admin can change individual users rights and provide individual operators with access to certain features, including, for example: financial reports and the ability to Pay ISC. FIG. 8 displays an administration super admin users setup screen.

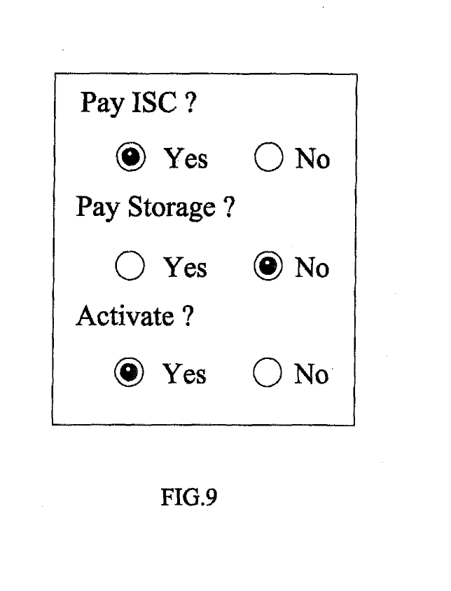

Second, an Accounting user of ePic has full access with the exception of user management rights. Finally, Operator users have Online Payment Access and operating reports only. FIG. 9 displays an administration operator access screen.

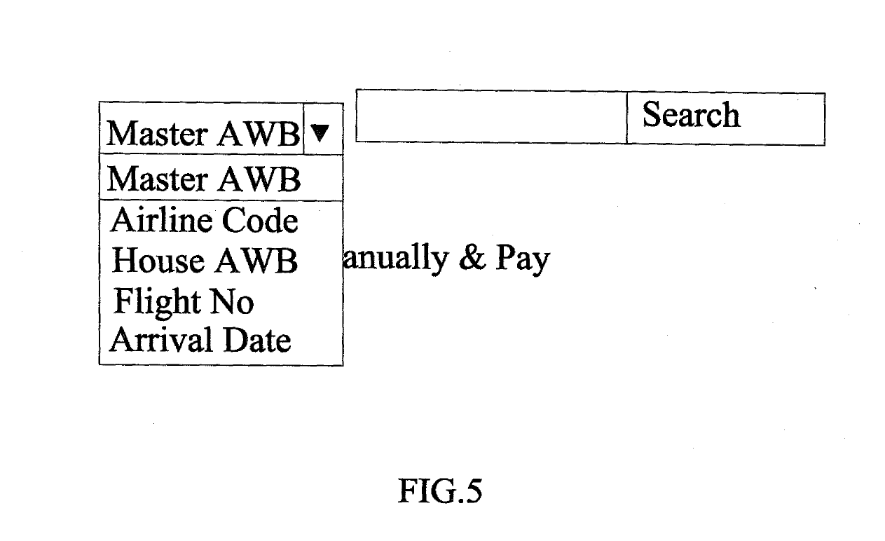

A Search box is also visible on the initial navigation page. FIG. 5 shows a search screen with searching options dropdown menu. The dropdown menu allows a user to search according to one of five criteria. First, the master AWB dropdown selection is used to search a return for a particular master AWB. Second, the airline code dropdown selection allows the user to filter the view and show only bills for a particular airline based on the associated airline prefix. Third, the house AWB dropdown selection permits a search and return based on a particular house AWB. Fourth, return all bills for a particular flight number, regardless of the date. Finally, a user may also search based on an arrival date.

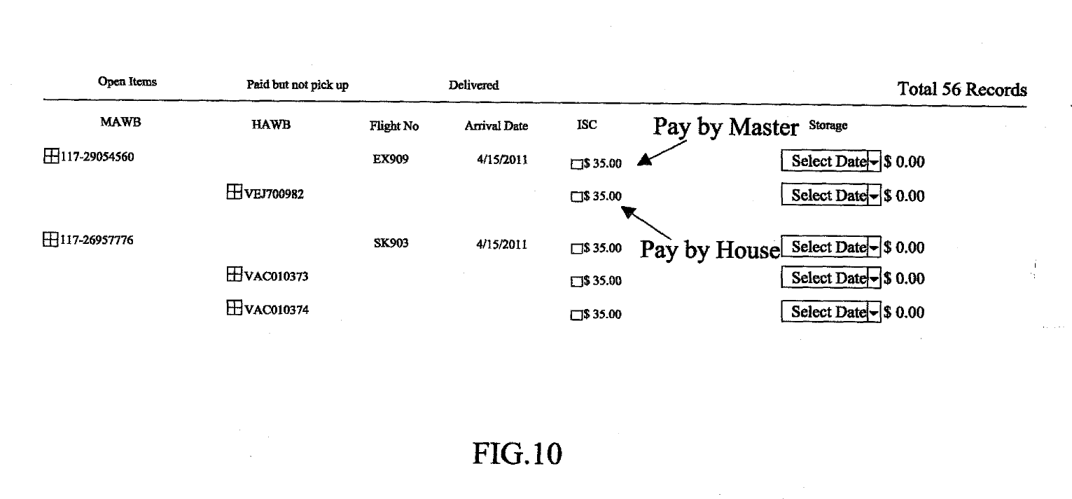

When the user first enters ePic, a list of shipments with messaging received that have not been yet been paid for will appear. The user may Click and Pay for these shipments. Instead, for example, if it is not a simple bill, the user may choose to pay by either master or house. FIG. 10 shows a paying ISC screen.

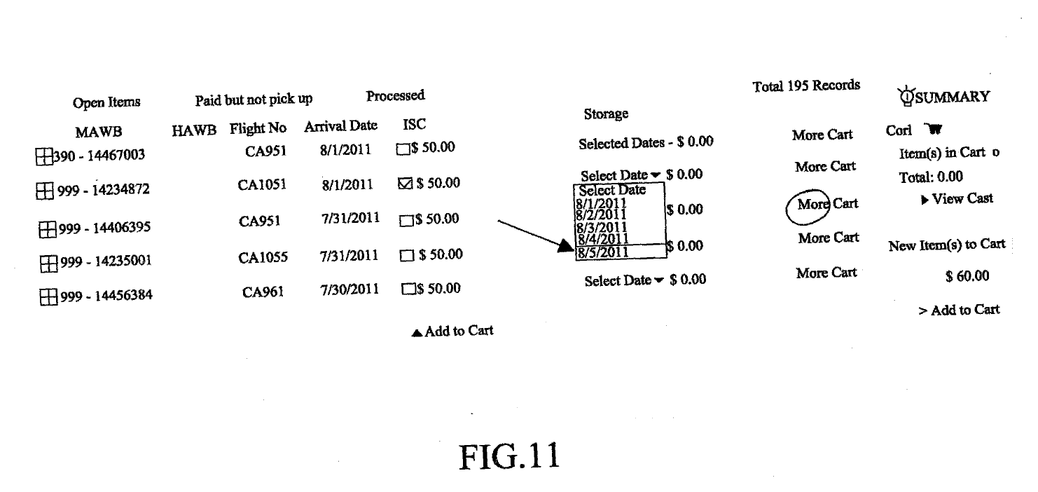

A user can automatically calculate storage and select a storage date from the drop down. The user may also add storage to most pre-existing shipments by clicking on the ‘more’ button, entering pickup date, and the amount. The ‘more’ button can be used as needed for additional storage. FIG. 11 shows a paying storage screen.

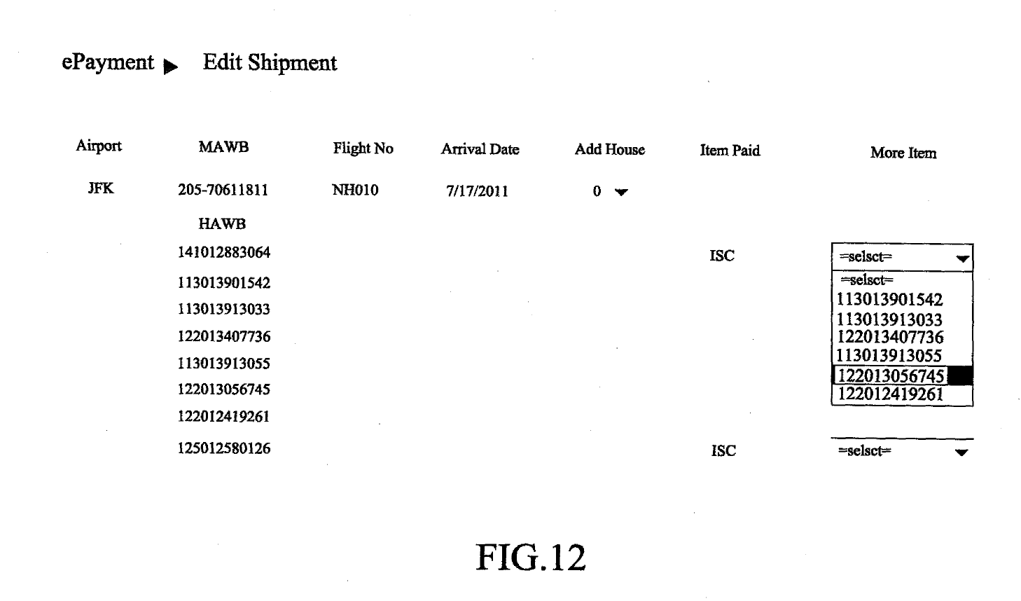

Under the ePayment edit tool, a user may add house AWBs and move pre-paid ISC payments. If the house is paid, but not picked up, you can move the associated ISC payment to any of the other houses under the same master AWB. FIG. 12 displays an epayment edit shipment screen.

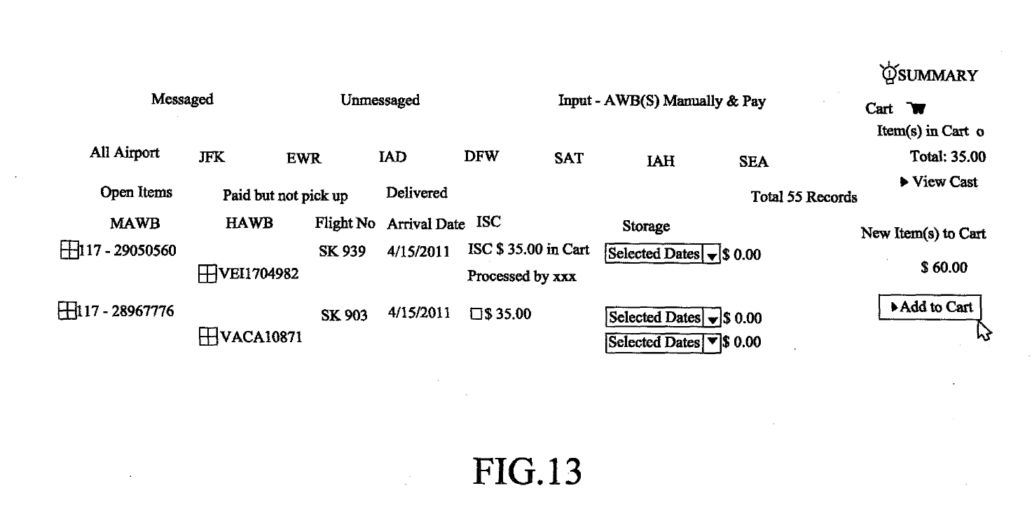

After selecting items, the user clicks the Add to Cart button. A user's items will be added to the cart. If a user would like to delete the item from the cart and return it to the open items list as payable, the Delete check box is clicked and then the Modify Cart appears. When ready to pay the View Cart button is clicked. FIG. 13 shows user cart screen. Storage and ISC items are listed as separate items. Until fully paid, the shipment remains in the Open Items section. Other stakeholders will be able to select the messages for payment while it is in the cart. Other users will be notified the subject messages are “In Cart” and payment options for them are not available.

When a user is ready to pay the Pay Now button is clicked. The user have the option to select his own reference number for each AWB item in the cart and then select his payment option. Payment options include, but are not limited to: paying by credit card, Paying by e-Check, and paying by pre-paid account. The most convenient way to pay is to establish a prepaid account. This is a pool of funds available to users to make payments from. It can be used to pay for both ISC and Storage. To pay a balance, simply select payment option and hit verify. As long as there are enough funds in the account, the transaction will be processed. To see the balance history click on the shortcut for Prepaid Balance. A receipt will be emailed to the main contact. The user may receive an email by entering an additional address.

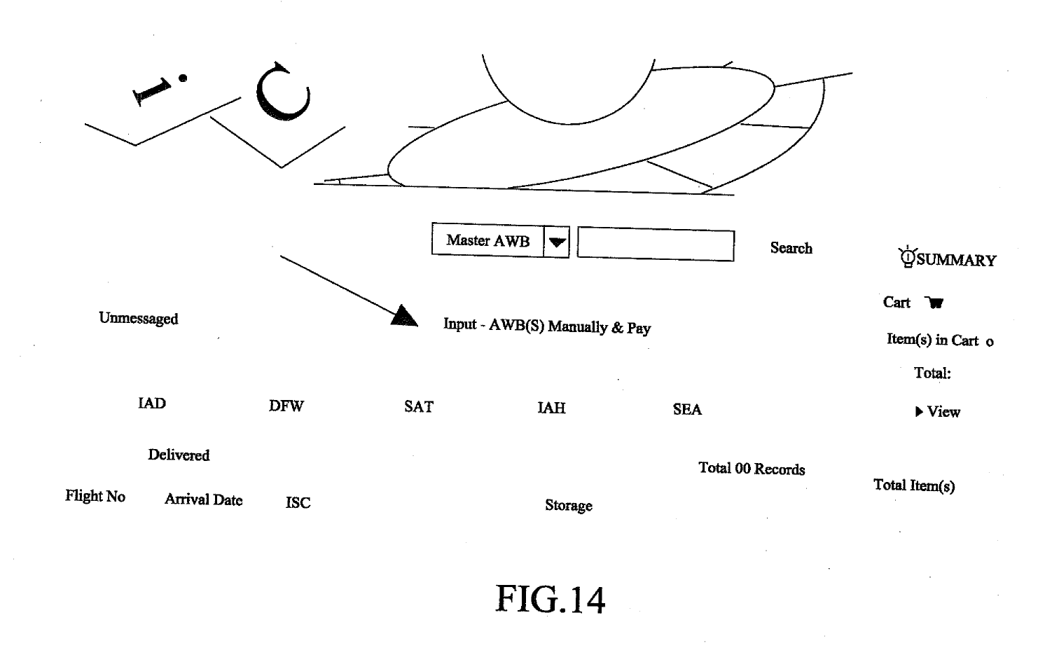

As discussed above, to pay for a shipment on one of the unmessaged airlines, a user can click on the button Input AWB (s) Manually and Pay. FIG. 14 shows a payment screen for an unmessaged shipment. To pay for an unmessaged shipment, a user should select based the corresponding airline prefix. An optional 2nd Code may be entered as necessary. These codes include: the AWB, the house AWB, the Flight Number, and the arrival Date.

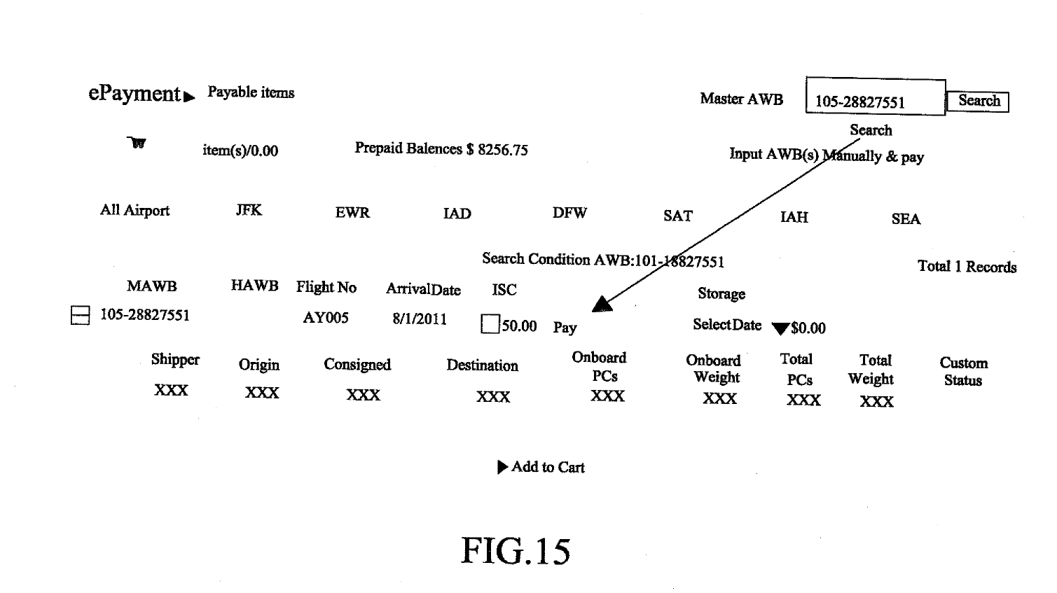

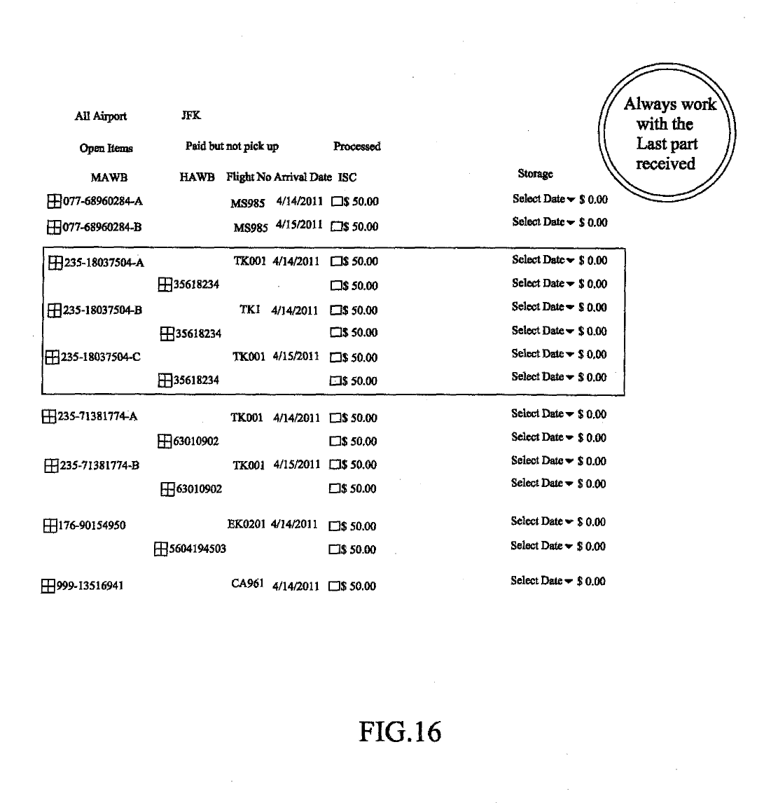

Also as indicated above, a user has the option to Search and Pay for messaged shipments prior to message arrival. FIG. 15 shows an epayment screen utilizing the search and pay for messaged shipments. A user can enter payments for master bills prior to their arrival using the Input AWB (s) Manually and Pay feature. Once the messaging arrives the AWB data is updated to your record and the user is able to use this feature for House AWBs. The Search and Pay feature also allows a particular user to pay for shipments not consigned to that particular user. Enter the whole master AWB into the Search field and the bill will be presented for payment. A user may also pay for partial shipments as they come in or once they all arrive. FIG. 16 shows a pay for partial shipments screen. The user is charged ISC once and storage for the whole shipment based on the portion of the whole that is selected. Storage is based on the total kilos for all parts being picked up and the arrival date of the flight. ISC is only charged once per master or house AWB.

Online payment as described above, eliminates the need for physical checks and simplifies the terminal service process. Access to online receipts provides the benefit of having one copy used by all the people all the time.

Additional features include: Auto-Notification, Bar-Code Pickup Pass, and Trace and Track. Auto-Notification allows a user to choose to receive pre-alerts and reminders sent via email or wireless device from the point of shipment arrival to the cargo pickup. Bar-Code Pickup Pass permits the user to receive payment receipt and pickup confirmation code generated online. Bar-code pickup pass results in faster cargo recovery for all stakeholders. Finally, Trace and Track, where a user may view complete shipment information and status, filtered according to parameters, includes: simple AWB, location, payment, consolidation, partial payment, proof of delivery, inbound shipment, freight condition, piece count, weight, customs release, and discrepancy. Trace and Track provides access cargo information from anywhere anytime.

ePic 2, the mobile warehouse management system, provides additional functionality and features, including automation of the delivery of and capture of information from the Cargo Handling Warehouse. ePic 2 reconfigures the cargo handling and optimizes the processes between the office and the warehouse, resulting in increased efficiencies. ePic 2 enables tablet-aided acceptance of cargo, buildup, breakdown, and delivery. Furthermore, ePic 2 empowers workforce by connecting cargo and data together resulting in process efficiency, quality improvement, increased productivity, SLA/C2K compliance, and enhanced employee satisfaction. ePic 2 provides auto DLV messaging to meet real-time C2K compliance with accurate truck waiting time. ePic 2 automatically prepares BCL to provide quicker cargo processing time and throughput. Finally, ePic 2 provides auto customs release to minimize the risk of customs fines and penalties.

Warehouse transportation vehicle(s), such as a forklift, are outfitted with mounting devices to a hold a SmartDevice. Other comparable devices with an Apple iOS or Android OS mobile device offering advanced capabilities, including personal computer-like functionality (PC-mobile handset convergence) or a palmtop computer may also be employed. The mounting device keeps the iPad protected, and accessible to the staff in a safe way. The staff sign into the SmartDevice and application to retrieve information about incoming or outgoing freight. They also capture all information regarding the freight required for handling.

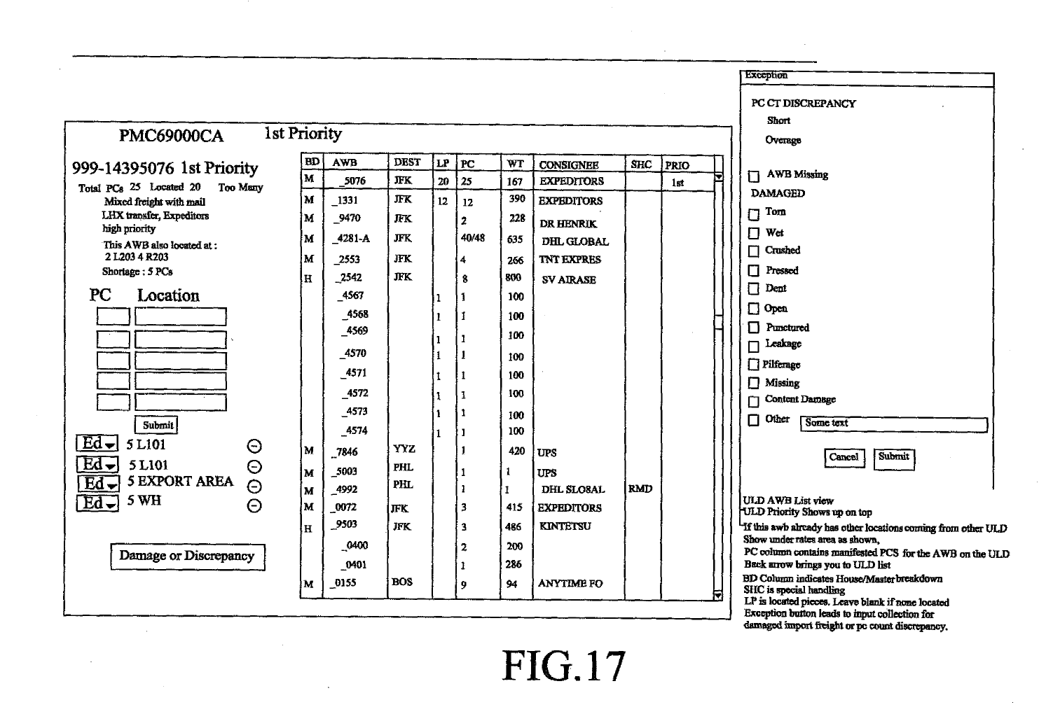

Warehouse staff are presented with a prioritized list of freight arriving at the warehouse for an import breakdown. FIG. 17 shows a screen displaying a prioritized list of freight arriving at the warehouse. As the freight is broken down on to skids, the agent enters piece counts and locations for those skids. The agent also notes any discrepancies.

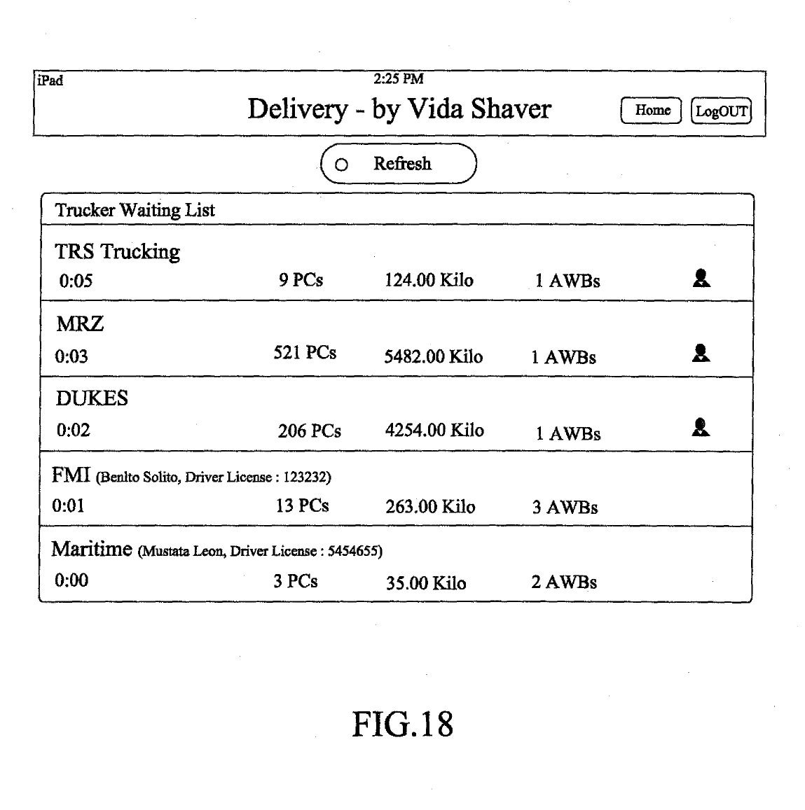

Warehouse staff are presented with a list of truckers that have checked in and are waiting to pick-up their freight for the import delivery. FIG. 18 shows a screen displaying list of truckers that have checked in and are waiting to pick-up their freight. Once a trucker is selected, they can see what freight it is and where it is located in the warehouse for retrieval. The warehouse agent uses the SmartDevice and application to note cargo data. They also check the ID of the driver against the ID appearing digitally in the system.

Warehouse staff are presented with a list of truckers that have checked in and are waiting to drop-off their freight. Once a trucker is selected, they can initiate the capture of critical acceptance cargo data.

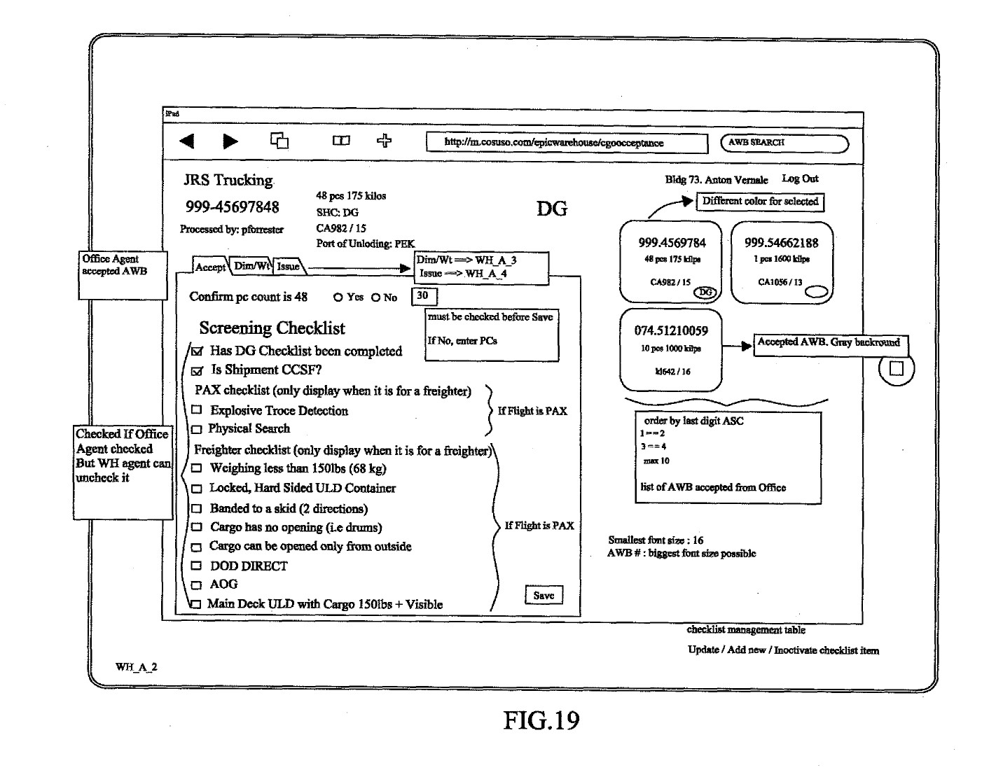

Warehouse staff select the flight they are performing a build up for and then create skids right in the application in an export build up. A skid is a temporary storage location for cargo, for example a pallet. FIG. 19 displays a screen showing an online freight build up and creating of a pallet. Freight is added to the pallet with simple clicks All critical build up data is captured including piece count, weights, dimensions, and special handling codes. A build up tag is printed out wirelessly by the scale to be attached to the freight.

Supervisors are provided with a SmartDevice with an app installed that will allow them to capture condition of the freight whether it is good or bad. For example, after freight is built up it is photographed to show it is in good condition and built properly. Or if freight arrives damaged it is photographed. All photos are associated with the freight and retrievable through our software.

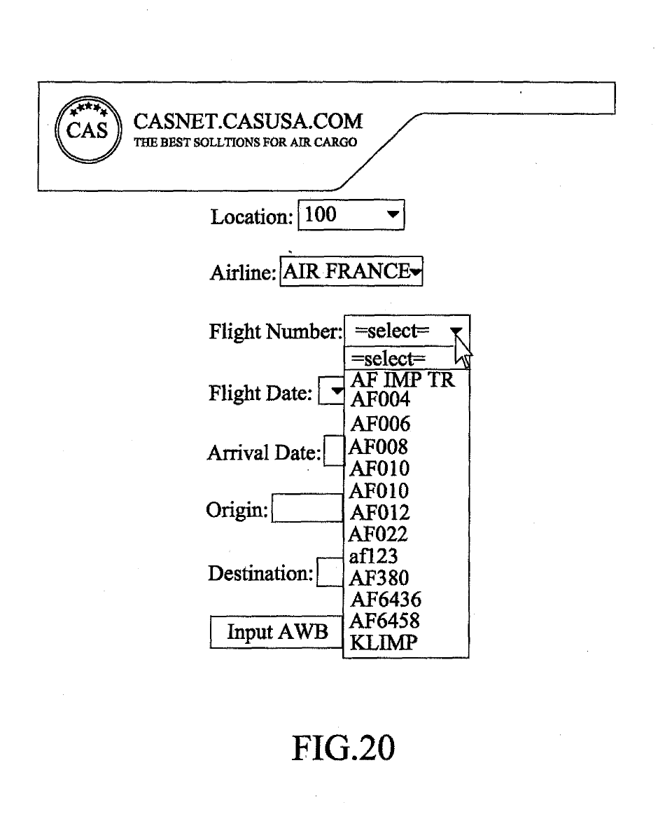

As discussed above, for airlines that do not provide message data, the information may be entered manually. ePic 2 provides an Import AWB Capture tool that allows stakeholders to quickly capture AWB data electronically. FIG. 20 shows an online tool allowing agents to capture AWB data electronically for airlines that do not provide message data. Once entered, the AWB is now treated as messaged and is used throughout the system.

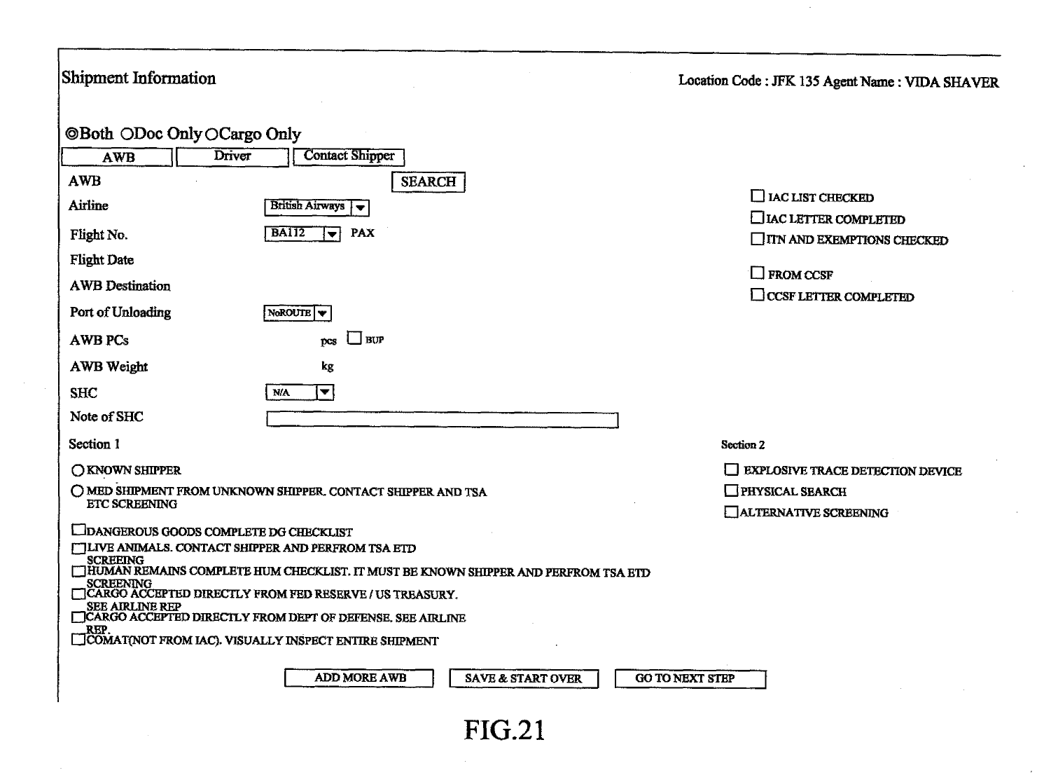

All office related export AWB acceptance data is captured through the ePic system. FIG. 21 Illustrates a display of all captured office related export acceptance data. The capture data includes: AWB and flight data, trucker identification, security checks, etc. Once captured, this data then becomes available throughout the system and enables a paperless export acceptance process.

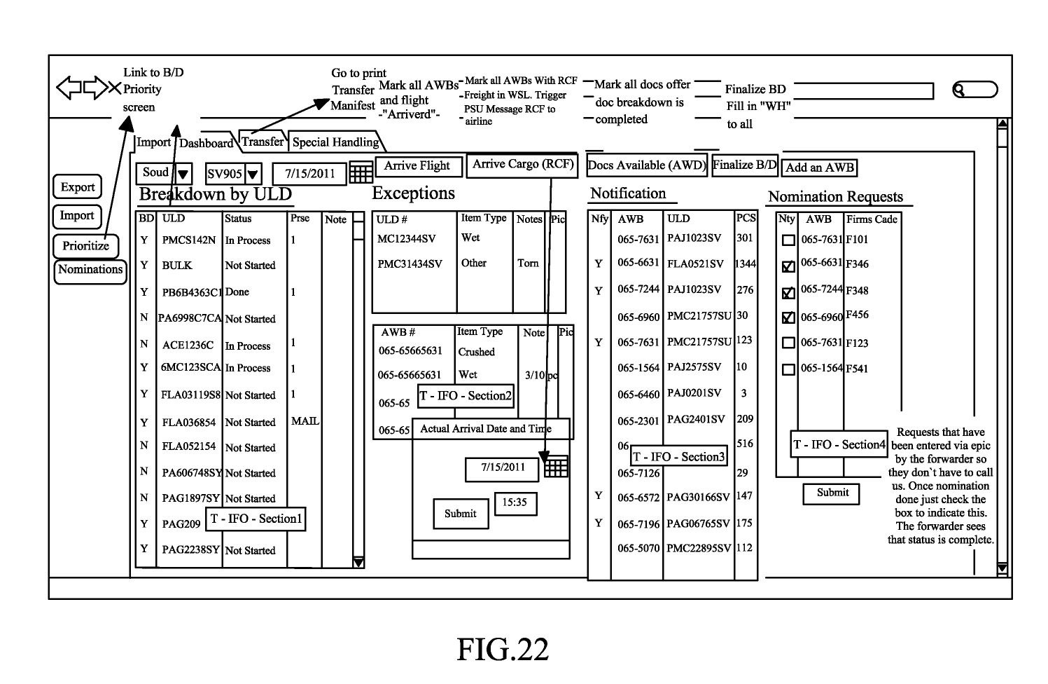

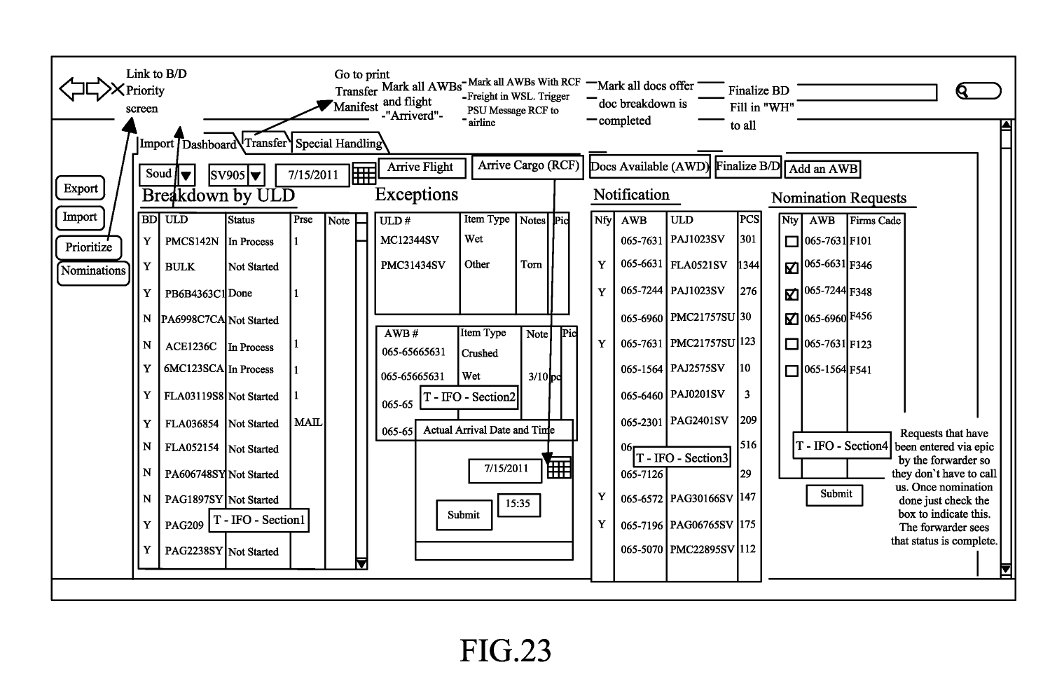

The import manager is a centralized view of all import processes being captured in the Warehouse or in the office. FIG. 22 shows a real-time centralized view of all import processes captured in a warehouse or office. The manager displays status of the breakdown, discrepancies, nomination requests and notification status. Similarly, the export manager is a centralized view of all export processes being captured in the Warehouse or in the office. FIG. 23 illustrates a real-time centralized view of all export processes being captured in the warehouse or in the office. The manager displays status of the outgoing flight including booking, acceptance, buildup and departure. The export flight manager also creates and sends export flight messaging to the airline handling system, such as FFM to make the build-up process faster in the office as well. The user also sees important information about freight being built that have special handling codes associated with them.

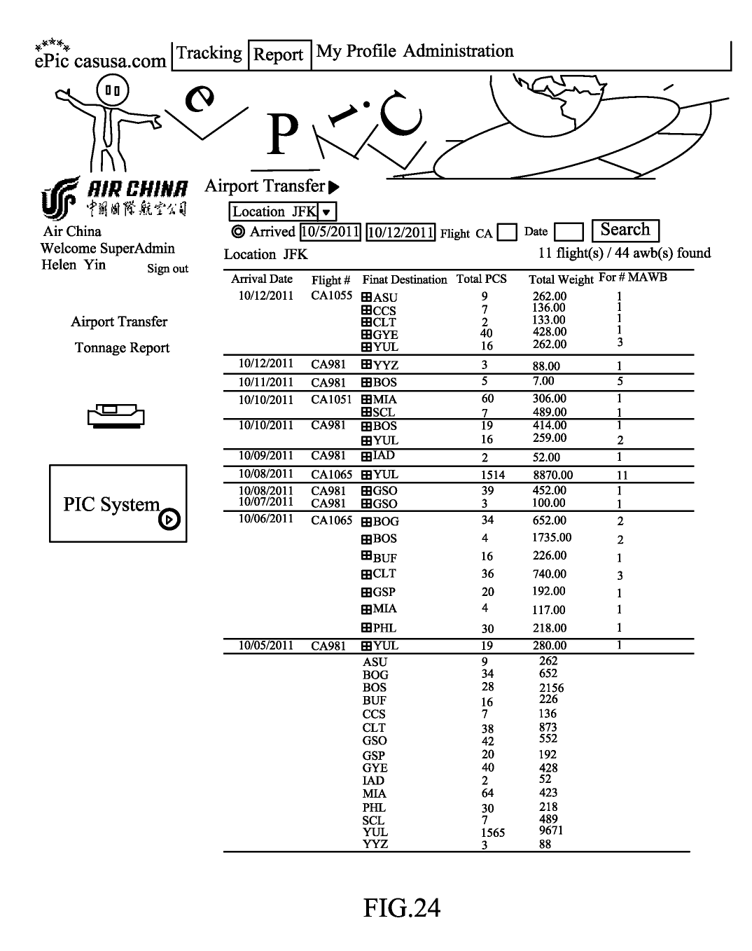

FIG. 24 shows the airline portal allowing customers access to their flight data, the ePic airline portal. This portal allows airline carrier customers access to their flight data. Data is presented in a user friendly way, in that data is consolidated into powerful business reports and can be easily filtered based on parameters. Inbound shipments can be tracked down to the proof of delivery where the user can actually see which trucker picked up the freight and when.

ePic 3 provides several additional features and functions, such as dock management, a manager module, Airline Portal Plus, and ePic Cloud.

Dock Door Management maximizes use of the dock doors to reduce the trucker waiting time as much as possible. The trucker engagements starts in the parking lot where the employee will be equipped with a SmartDevice and application to identify the trucker and capture basic details to alert the warehouse staff of his arrival and what to prepare for. The trucker is then assigned a door based on complexity of the shipment they are dropping off or picking up and what is currently happening at each dock door. For facilities that are not busy, the freight can start to be retrieved and staged before the trucker is even walking through the traffic doors to check in. A qualifying trucker can skip the manual check-in process altogether and go straight to the dock door. For busier facilities, freight will move through faster with less unnecessary waiting by the trucker.

The Manager Module provides warehouse managers a SmartDevice application, so that the manager can set priorities for staff, complete shift reporting, fill out accident or incident reports, capture images, monitor the operations and communicate with staff and customers.

Airline Portal Plus includes an engine allowing airlines to forward all of the flight data, even for stations that are not handled in order that they can achieve reporting across their entire enterprise.

ePic Cloud is a commerce platform for the air cargo community where partners can pay each other or transact with each other. Social network features such as user profiles, online presence, and document sharing will be part of the applications.

What is claimed is:

1. A method for cargo handling using a computer program product having a computer usable medium and computer readable program code embodied therein, the computer readable program code adapted to be executed to implement the method for cargo handling, the method comprising:
a. identifying, with respect to a customer, cargo data;
b. transmitting the cargo data to a customer service portal and a mobile warehouse management system, wherein the mobile warehouse management system is at least one SmartDevice located in a warehouse; and
c. transmitting the data from the at least one SmartDevice to at least one other SmartDevice and to the customer service portal for real-time access to the goods to which the cargo data refers while processing the cargo through a logistic chain.

2. The method of claim 1, wherein the airline data (the Cargo—1MP communication protocol used by the IATA) includes FFM, FWB, FHL, and FSU(RSC) messages.

3. The method of claim 1, further comprising:
a. identifying the data with respect to a customer; and
b. providing a customer access to view the data.

4. The method of claim 3, wherein the identifying step is accomplished through a Bar-Code Pickup Pass.

5. The method of claim 1, further comprising: using a Trace and Track for at least one cargo shipment by the customer to obtain cargo data.

6. The method of claim 5, wherein the Trace and Track is consolidated into a business report that a customer may filter based on a selected parameter.

7. The method of claim 6, wherein the selected parameters include simple AWB, location, payment, consolidation, partial payment, proof of delivery, inbound shipment, freight condition, piece count, weight, customs release, and discrepancy.

8. The method of claim 1, further comprising: paying electronically for messaging by the customer.

9. The method of claim 1, further comprising: notifying the customer automatically through an email.

10. The method of claim 1, further comprising: notifying the customer automatically through a message to a wireless device.

11. The method of claim 1, wherein the airline data is captured by manually entering an AWB information for an unmessaged airline.

12. A computer implemented cargo management system comprising:
a. a messaging engine for transmitting airline data via IATA messaging to a customer service portal and a mobile warehouse management system;
b. a customer service portal for a stakeholder to manage, track, or reconcile a shipment through the internet; and
c. a mobile warehouse management system.

13. The system of claim 12, wherein the mobile warehouse management system comprises at least one SmartDevice for electronically transmitting cargo data in real-time to each party in a logistics chain and to the customer service portal.

14. The system of claim 13, wherein the mobile warehouse management system further comprises:
a. a SmartDevice located in a parking lot for identifying a trucker and capturing basic freight details and communicating those details to a warehouse;
b. a SmartDevice located in a warehouse office for receiving and transmitting data and assigning the trucker a dock door;
c. a SmartDevice in a warehouse for preparing for the trucker's freight on acceptance or for delivery.

15. The system of claim 13, wherein the SmartDevice prioritizes a breakdown or a buildup.

16. The system of claim 13, wherein the SmartDevice provides notice of special handling instructions.

17. The system of claim 13, wherein the SmartDevice is mounted to a warehouse transport vehicle.

18. The system of claim 13, wherein the SmartDevice transmits data for at least one customer after cargo is added to a skid or removed from a skid.

19. The system of claim 13, wherein the SmartDevice notifies the warehouse when at least one trucker has checked in and is waiting to drop-off cargo.

20. The system of claim 13, wherein the SmartDevice creates a buildup for a selected flight by adding freight to a skid.

21. The system of claim 13, wherein the SmartDevice allows a centralized view that shows a status of all bookings, acceptances, and related cargo data.
